(19) United States
(12) Patent Application Publication
(10) Pub. No.: US 2026/0261178 A1
(43) Pub. Date: Sep. 3, 2026

(54) ACTUATOR FOR MOTOR VEHICLE APPLICATIONS

(71) Applicant: KIEKERT AKTIENGESELLSCHAFT, Heiligenhaus (DE)

(72) Inventors: Stefan ADAMIK, Velbert (DE); Michael BERRES, Köln (DE)

(73) Assignee: KIEKERT AKTIENGESELLSCHAFT, Heiligenhaus (DE)

(21) Appl. No.: 18/718,207

(22) PCT Filed: Dec. 16, 2022
(86) PCT No.: PCT/DE2022/100963

§ 371 Date: Jun. 10, 2024

(30) Foreign Application Priority Data
Dec. 21, 2021 (DE) 10 2021 133 973.1

(51) Int. Cl. H02K 5/22

(52) U.S. Cl. CPC H02K 5/225; H02K 2205/09

(57) ABSTRACT

An actuator for motor vehicle applications, having an actuating element, an electric motor and a transmission connected downstream of the electric motor, wherein the actuating element is movable into and out of a housing of the actuating element by means of the transmission, and having a connection socket for electric contacting of the actuator with a connection plug, wherein the pressure in the actuator can be equalized by means of the connection socket.

The invention relates to an actuator for motor vehicle applications having an actuating element, an electric motor, and a transmission connected downstream of the electric motor, wherein the actuating element is movable into and out of a housing of the actuating element by means of the transmission, and having a connection socket for electric contacting of the actuator with a connection plug.

Actuators are used in motor vehicles where actuating movements or locking mechanisms are required, a tank locking mechanism, a charging plug locking mechanism or the positioning of a flap element being mentioned by way of example. This list is of course not restrictive, but merely shows the wide range of applications for an actuating element in a motor vehicle. Electric drives having an actuating element are usually used where comfort functions are to be increased or the vehicle needs to be secured. The actuator can be used, for example, to lock a fuel filler flap or a charging plug in a hybrid or electric vehicle. In this case, the actuating element that can be extended from or retracted into the actuator housing is used, for example, to serve directly as a latch or to actuate a latching element in such a manner that, for example, opening of a fuel filler flap can be prevented.

In this case, depending on how the actuator is used in the motor vehicle, the actuator may be exposed to external weather conditions and must be protected from moisture in particular. If the actuator is used, for example, in a loading flap of an electric vehicle or in the region of a fuel filler flap, the actuator can be used to lock the flap and/or open the flap. In any case, this region must be protected against the ingress of environmental influences such as rain, snow or dust, so that tight sealing of the actuator housing, but also of the actuator itself, must be ensured. Sealing with regard to environmental influences requires that the functional components in contact with the actuator, such as the motor and transmission, must be sealed in the actuator. In this case, the tight fastening of the actuator element in the actuator can impair the functioning of the actuator element, as pressure differences occur in the actuator element due to the movement of the actuator element and/or other sealing means. These pressure differences can impair the function of the actuator element, i.e., the back-and-forth movement.

A generic actuator is known from DE 102 59 465 A1 The publication discloses an actuator for motor vehicle applications, having an actuating element, an electric motor and a transmission connected downstream of the electric motor, wherein the actuating element can be moved into and out of the housing of the actuating element by means of the transmission. In this case, the actuating element itself is accommodated in a bellows, the bellows sealing or accommodating the actuating element in relation to the housing. In order to counteract the pressure differences in the housing of the actuator and at the same time protect the functional components of the actuator from moisture, an air-permeable but moisture-impermeable membrane is arranged in the housing. The membrane consists of a semi-permeable plastic material made of a semi-permeable and direct PTFE. This semi-permeable layer is supported and held by a load-bearing layer made of a carrier material, also made of plastics material. Polyamide (PA) is usually used here, it being possible for both layers to be connected together using an adhesive.

The use of an air-permeable but moisture-impermeable membrane when deployed in an actuator has generally proven to be successful. A problem that always arises when installing actuators is that sufficient installation space and accessibility for the actuator must be ensured. Particularly in the region of flaps, but also in the region of doors, the installation space can be limited or can only be achieved by directly fitting the actuator into the installation space. Therefore, sufficient ventilation of the actuator or the functional components of the actuator cannot be ensured in all cases. This is where the invention starts.

The object of the invention is to provide an improved actuator. In particular, it is an object of the invention to provide a possibility to enable safe ventilation of the actuator even when there is limited accessibility to the actuator. In addition, the object of the invention is to provide a structurally simple and cost-effective solution for venting and deaerating the actuator.

The object is achieved according to the invention by the features of independent claim 1. Advantageous embodiments are specified in the dependent claims. However, it should be noted that the exemplary embodiments described in the following are not limiting; rather, any number of possible variations of the features described in the description, the claims, and the drawings are possible.

According to claim 1, the object of the invention is achieved in that an actuator for motor vehicle applications is provided, having an actuating element, an electric motor, a transmission connected downstream of the electric motor, wherein the actuating element is movable into and out of a housing of the actuating element by means of the transmission, and having a connection socket for electric contacting of the actuator with a connection plug, wherein pressure compensation in the actuator can be realized by means of the connection socket. By moving the pressure equalization to the region of the connection socket, a region of the actuator can now be used for venting and deaerating, which must generally be available for contacting the actuator. The actuator requires an electrical contact to operate the electric motor so that on the one hand, controlling the functional components of the actuator can be ensured, and on the other hand control means arranged in the actuator, such as microswitches, can be connected. Advantageously, a region of the actuator is thus available for venting and deaerating, which is sealed by the plug-socket connection on the one hand and forms a contact point between the actuator and the motor vehicle on the other hand. This contact region is in particular sealed by the plug-socket connection so that pressure equalization or venting and deaerating can be carried out through the connection socket without additional sealing measures in the actuator. In particular, the entire housing of the actuator can be tightly sealed all around, which in turn is an advantage for use even in a region subject to strong environmental influences. The venting and deaerating or pressure equalization takes place in a region of the connection socket, which shifts the venting and deaerating to a region outside the functionalities of the actuator.

In the housing and within the connection socket, an opening can be arranged in the housing. The housing of the actuator encloses the functional elements, electric motor, transmission, switching means, actuating element and/or electrical control parts, wherein the housing has a recess only in the region of the actuating element through which the actuating element can be moved out of the housing and into the housing. The actuating element itself can, as is known from the prior art, be sealed by, for example, a bellows. The housing itself can be closed by a circumferential seal and/or, for example, by means of a laser welding method. This type of sealing of the functional components and the interior of the actuator can ensure use even under extreme weather conditions. Since the pressure equalization has also been shifted to a region that is separately sealed by the plug-socket connection, improved tightness can be achieved with unchanged functionality.

In an advantageous way, a vent cooperating with the opening is provided in the connection plug. The connection socket opening and the connection plug cooperate in such a way that on the one hand, an opening is provided in the housing and on the other hand, ventilation through the plug can be ensured. The connection plug for the actuator is designed in such a way that the opening is at least partially overlaid by the vent of the connection plug, so that pressure equalization starting from the actuator of the connection plug is possible. If, for example, the actuating element is moved from an extended position into a retracted position in the actuator, an increased pressure in the actuator can occur due to the tightness of the actuator and the bellows in the region of the actuating element. This pressure can be equalized through the opening in the housing and in the region of the connection socket, since pressure equalization is possible through the opening in the direction of the connection plug. Even if a bellows is primarily described here for sealing the actuating element, it is of course also conceivable that a seal integrated into the housing, through which the actuating element is moved, can be used to seal the actuating element.

In an advantageous embodiment of the invention, the openings and a vent opening are directly adjacent to one another. The opening in the connection socket forms an opening in the direction of the functional components of the actuator and is connected to the interior of the actuator in such a way that, for example, arising humidity can escape from the opening, or air circulation into the sealing groove interior the actuator is made possible. The openings within the connection socket are located directly next to a vent opening in the connection plug, i.e., the openings in the connection socket and the vent openings in the connection plug advantageously have the same or almost the same dimensions. The direct proximity as well as the matching dimensions can ensure that the interior of the actuator is ventilated and deaerated as efficiently as possible.

It can also be advantageous and form an embodiment variant of the invention if the vent opening is part of a vent channel in the connection plug. The vent opening forms a recess in the connection plug corresponding to the opening in the housing. The ventilation duct is connected to the ventilation opening, which in turn advantageously allows the ventilation to be guided into a region which, in relation to the arrangement of the plug in the actuator or in the motor vehicle, is suitable for favorable ventilation and deaeration. This means that venting can also take place in regions that are arranged at a distance from the actuator.

If the connection plug has an outlet opening, in particular an outlet opening for the ventilation duct, this results in a further embodiment variant of the invention. The connection plug can, for example, have an opening in the region of a line connection or a cable exiting the plug if this opening is arranged, for example, in a dry region of the motor vehicle. It is therefore also conceivable that, for example, the ventilation duct extends along the plug and at least partially also along the connection cable or the control line for the actuator. The ventilation opening or the ventilation duct then has an outlet opening which is not subject to any further environmental influences in the dry region of the motor vehicle. However, the outlet opening can also be arranged directly in the plug element of the connection plug if the connection plug is located far enough away from the area of influence of rain, dust, etc. that unhindered ventilation and deaeration is possible. Advantageously, the outlet opening can be made impermeable to moisture. In this embodiment variant, an outlet opening can be provided in the connection plug itself, which then serves to equalize the pressure and protect against the ingress of moisture. This means that the housing of the actuator can be sealed all around and, for example, pressure equalization can be achieved via the plug connection in the actuator.

The outlet opening can be supported and held with a semi-permeable plastic material with a supporting layer made of a carrier material, also made of plastic. A polyamide is usually used here, wherein both layers can be connected together by an adhesive. The outlet opening sealed using semi-permeable plastic ensures that an air exchange is guaranteed between the interior of the actuator, or the bellows and the housing, and the outside ambient air, without moisture being able to penetrate. However, this prevents the formation of condensate in the interior of the actuator and ensures pressure equalization when there are movements of the actuating element between the internal volume and the external ambient air.

In a further embodiment variant, the outlet opening is arranged at an end of the connection plug opposite the vent opening. A ventilation opening running substantially straight can ensure safe ventilation and deaeration of the interior. In addition, this design provides a cost-effective and structurally simple way of providing ventilation and deaeration for the actuator.

Advantageously, a plug seal is arranged in the region between the opening and the vent opening between the connection plug and the connection socket. The plug seal completely encloses the openings in the connection plug and in the connection socket, so that additional security can be provided for sealing the housing of the actuator.

In the following, the invention is explained in more detail with reference to the appended drawings using an embodiment. However, the principle applies that the exemplary embodiment does not limit the invention, but is merely an advantageous embodiment. The features depicted can be implemented individually or in combination with further features of the description as well as what is claimed—individually or in combination.

In the figures:

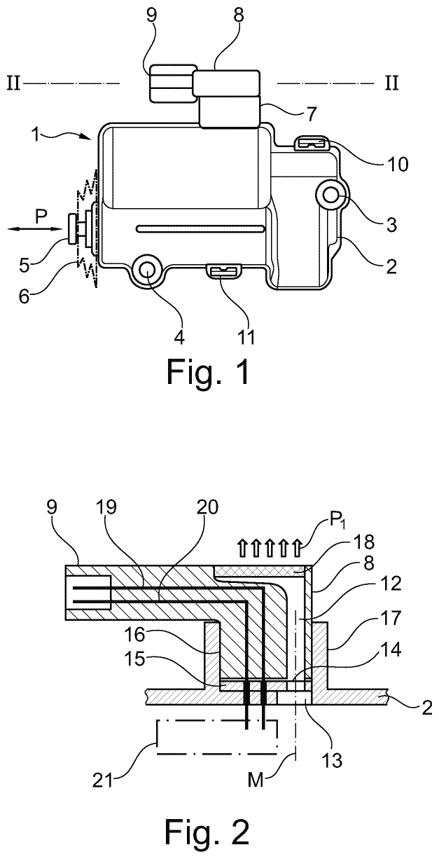

FIG. 1 shows a plan view of an actuator with a connection socket and a connection plug inserted into the connection socket; and

FIG. 2 shows a schematic representation through a connection plug designed according to the invention along the line II-II in FIG. 1.

FIG. 1 depicts a plan view of an actuator 1 and in particular of a housing 2 of the actuator 1. The housing 2 has through holes 3, 4, by means of which the actuator 1 can be arranged, for example, on a motor vehicle in the region of a charging socket. An actuating element 5 can be moved out of and back into the housing 2 of the actuator 1 in the direction of arrow P. The actuating element 5 can be sealed during movement by means of a bellows 6 indicated as a dash-dotted line. The actuator 1 has a connection socket 7 into which a connection plug 8 is shown inserted as a separate component. The connection plug 8 in turn has a connection socket 9, wherein the connection socket 9 can serve, for example, as a motor vehicle-specific plug interface.

The actuator housing 2 can, for example, be connected to a clip connection 10, 11 to be mounted, and/or can have a circumferential laser-welded connection.

FIG. 2 depicts a schematic representation of a connection plug 8 designed according to the invention. FIG. 2 shows a section through a ventilation duct 12 in the interior of the connection plug 8. An opening is arranged in the housing 2 of the actuator 1, which corresponds in position to a vent opening 14. A plug seal 15 is arranged between the connection plug 8 and the connection socket 7, which serves to seal between the connection components 7, 8. Additional circumferential seals 16 can be arranged, for example, on an upper edge of the connection socket 7 and/or on the connection plug 8.

The ventilation duct 12 extends substantially in a straight line along a center line M through the connection plug 8 and is widened at the end, wherein the ventilation duct 12 ends in an air-permeable but moisture-impermeable membrane 18. The membrane 18 is capable of allowing air to pass through the membrane 18, for example in the direction of the arrows P1, in the event of an overpressure in the actuator 1, whereas the membrane 18 is designed impermeable to moisture. Pressure equalization or venting of the actuator 1 is of course also possible through the membrane 18.

The connection plug 8 is used to control the actuator and to make electrical contact with the components in the interior of the actuator 1. For this purpose, examples of control and supply lines 19, 20 are shown schematically in FIG. 2. The control and supply lines 19, 20 can be connected on one side to, for example, an electric motor 21, whereas the control and supply lines 19, 20 can be connected to a motor vehicle-specific plug by means of the connection socket 9.

Due to the design according to the invention of venting and deaerating for the actuator 1, pressure equalization or venting and deaerating for the actuator 1 can be shifted to a region outside the housing 2. This allows ventilation and deaeration processes to be shifted to regions that are less or not at all subject to environmental influences.

### LIST OF REFERENCE SIGNS

1 Actuator
2 Housing
3, 4 Through holes
5 Actuating element
6 Bellows
7, 9 Connection socket
8 Connection plugs
10, 11 Clip connection
12 Ventilation duct
13 Opening
14 Ventilation opening
15 Plug seal
16 Circumferential seal
17 Edge
18 Membrane
19,20 Electrical control and supply line
21 Electric motor
P, P1l Arrow
M Center line

1. An actuator for motor vehicle applications comprising:
an actuating element having a housing, an electric motor, and a transmission connected downstream of the electric motor,
wherein the actuating element is movable into and out of a housing of the actuating element by operation of the transmission, and
a connection plug and a connection socket for electric contacting of the actuator with a connection plug, wherein a pressure in the actuator is equalized by the connection socket.

2. The actuator according to claim 1, further comprisingan opening that is arranged in the housing and within the connection socket.

3. The actuator according to claim 2, further comprisinga vent cooperating with the opening in the connection plug.

4. The actuator according to claim 2, wherein the vent includes a ventilation opening, and wherein the opening and a ventilation opening are directly adjacent to each other.

5. The actuator according to claim 4, wherein the ventilation opening is part of a ventilation duct in the connection plug.

6. The actuator according to claim , wherein the connection plug has an outlet opening for the ventilation duct.

7. The actuator according to claim 6, wherein the outlet opening is designed impermeable to moisture.

8. The actuator according to claim 6, wherein the outlet opening is sealed with a semi-permeable plastic that is permeable to air and impermeable to moisture.

9. The actuator according to claim 6, wherein the outlet opening is arranged at an end of the connection plug opposite the ventilation opening.

10. The actuator according to claim 1, wherein the connection plug is designed as a separate component and has a second connection socket for a motor vehicle connection.

11. The actuator according to claim 3, wherein the opening is at least partially overlaid by the vent.

12. The actuator according to claim 4, further comprising a plug seal that is arranged between the opening and the ventilation opening between the connection plug and the connection socket.

13. The actuator according to claim 1, further comprising a bellows that seals the actuating element at the housing.

14. The actuator according to claim 1, wherein the ventilation duct extends in a straight line along a center line through the connection plug and is widened at an end of the ventilation duct.
